(19) United States
(12) Patent Application Publication
(10) Pub. No.: US 2018/0102836 A1
(43) Pub. Date: Apr. 12, 2018

(54) OPTICAL TRANSCEIVER AND DEVICE

(71) Applicant: NEC CORPORATION, Tokyo (JP)

(72) Inventor: Kohei IWANAGA, Tokyo (JP)

(21) Appl. No.: 15/728,636

(22) Filed: Oct. 10, 2017

(30) Foreign Application Priority Data
Oct. 11, 2016 (JP) 2016-199711

(51) Int. Cl. H04B 10/075; H04B 10/40

(52) U.S. Cl. CPC H04B 10/075; H04B 10/40

(57) ABSTRACT

The object of invention is providing an optical transceiver enhancing the probability of allowing the deterioration of an optical path to be correctly determined, and making it possible not to install a device for measuring the deterioration of characteristics of the optical path at the outside the optical transceiver. The optical transceiver includes a light emitting section, a light receiving section, and a determination section. The light emitting section transmits a first light signal to a second optical transceiver via an optical path. The light receiving section receives a second light signal transmitted from the second optical transceiver via the optical path. The determination section outputs the result of a determination on the amount of the change from an initial value to a value representing a received light amount in the reception by the light receiving section with respect to the second optical signal obtained at a predetermined timing point.

This application is based upon and claims the benefit of priority from Japanese Patent Application No. 2016-199711, filed on Oct. 11, 2016, the disclosure of which is incorporated herein in its entirety by reference.

### TECHNICAL FIELD

The present invention relates to an optical device that performs optical communication with other optical devices.

### BACKGROUND ART

Any deterioration due to temporal change and the like in an optical path, such as an optical fiber path, for use in connection between optical transceivers causes deterioration of quality of communication therebetween, and may disconnect the communication therebetween in the worst case. Particularly, optical paths used in access systems constituting end portions of optical networks are drawn into, for example, base stations, offices, and factories for mobile radio communication are always in a state of being exposed to influence of external environment. Such optical paths, therefore, are always in a state of being likely to be deteriorated.

Accordingly, it is required to detect the deterioration of an optical path and take prompt measures against it at an early stage where the deterioration of the quality of optical communication is not yet progressed to a situation where the optical communication is brought Into a disabled state.

Here, in Japanese Unexamined Patent Application Publication No. 4-242116, there is disclosed an optical receiver including a comparison circuit configured to compare a stored and input digital value of the amplitude level of a received light signal with a corresponding, immediately previously stored digital value of the amplitude level of the received light signal, and output a warning signal when a difference beyond a predetermined value exists between the two kinds of digital values.

Further, in Japanese Unexamined Patent Application Publication No. 2016-096511, there is disclosed an optical transceiver configured to, when, based on monitoring information, having detected that a monitored value of a received power level has been reduced beyond the variation of an optical path, update the record of output power states of a light source.

Further, in Japanese Unexamined Patent Application Publication No. 2004-172741, there is disclosed a transmission failure determination device configured to, when having detected that a received light level at a receiver has been reduced to level lower than a reference level, determine a cause of the reduction of the received light level on the basis of the properties of fluctuations of the received light level during a constant period after the detection.

Further, in Japanese Patent No. 5415651, there is disclosed a signal monitoring device configured to, for each of monitored signals, temporally sequentially calculate difference values between values of the each signal and a preset threshold value to perform updating and storage of the temporally sequentially calculated difference values in accordance with a predetermined rule.

In the method disclosed in Japanese Unexamined Patent Application Publication No. 4-242116, a stored and input digital value of the amplitude level of a received light signal is compared with only a corresponding, immediately previously stored digital value of the amplitude level of the received light signal. Thus, in the case where the signal level is gradually reduced and comes to a largely reduced state, any abnormal condition of the amplitude level may be unlikely to be detected.

Moreover, it seems that there is an assumption that, when the method disclosed in Japanese Unexamined Patent Application Publication No. 4-242116 is applied, the comparison circuit is installed outside the optical transceiver. For the optical path, however, there is a limit in the securement of an installation place and electric power. For this reason, it is difficult to install a dedicated measurement tool including the comparison circuit.

### SUMMARY

It is an object of the present invention to provide an optical transceiver or the like that enables achievement of enhancing the probability of allowing the deterioration of an optical path to be correctly determined, and making it possible not to install a device for measuring the deterioration of characteristics of the optical path at the outside of the optical transceiver.

An optical transceiver according to an aspect of the invention includes a light emitting section, a light receiving section, and a determination section. The light emitting section transmits a first light signal to a second optical transceiver via an optical path. The light receiving section receives a second light signal transmitted from the second optical transceiver via the optical path. The determination section outputs the result of a determination on the amount of the change from an initial value to a value representing a received light amount in the reception by the light receiving section with respect to the second optical signal obtained at a predetermined timing point.

The optical transceiver or the like according to the present invention enables achievement of enhancing the probability allowing the deterioration of an optical path to be correctly determined, and making it possible not to install a device for measuring the deterioration of characteristics of the optical path at the outside the optical transceiver.

### BRIEF DESCRIPTION OF THE DRAWINGS

Exemplary features and advantages of the present invention will become apparent from the following detailed description -when taken with the accompanying drawings in which:

FIG. 1 is a conceptual diagram illustrating an example of the configuration of an optical transceiver according to the present embodiment;

FIG. 2 is a conceptual diagram illustrating an example of the configuration of a light adjusting section;

FIG. 3 is a conceptual diagram illustrating an example of the configuration of a processing section;

FIG. 4 is a conceptual diagram illustrating an example of information retained by a memory;

FIG. 5 is a conceptual diagram illustrating an example of information retained by a recording section;

FIG. 6 is a conceptual diagram illustrating an example of a process flow for processing performed by a monitor processing section; and

FIG. 7 is a block diagram illustrating a minimum configuration of an optical transceiver according to the present invention.

### EXAMPLE EMBODIMENT

Next, a detailed explanation will be given for a first example embodiment with reference to the drawings.

[Configuration and Operation]

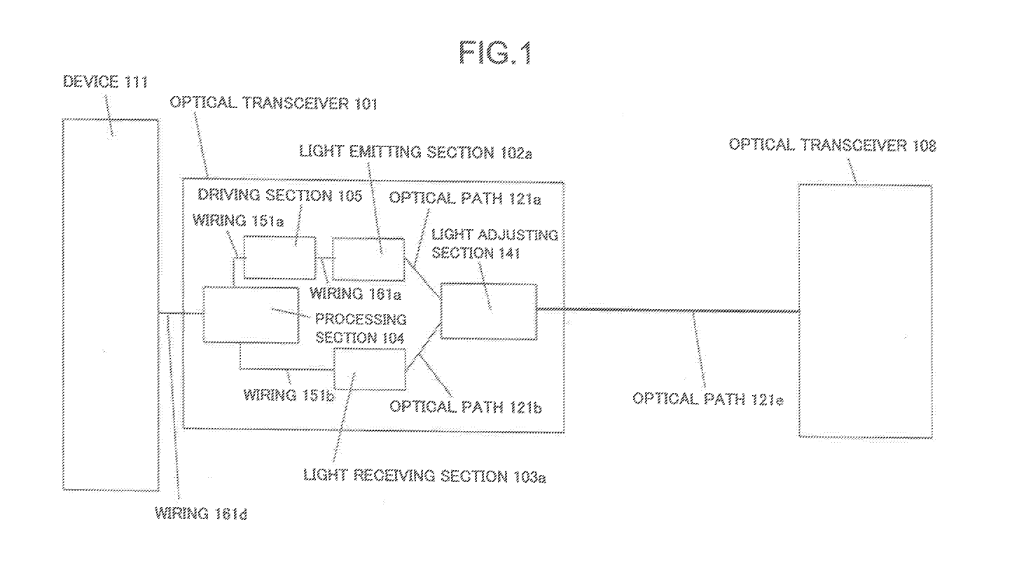

FIG. 1 is conceptual diagram illustrating a configuration of an optical transceiver 101, an example of an optical transceiver according to this embodiment. In FIG. 1, a device 111, a wiring 161d, an optical path 121e, and an optical transceiver 108 are also illustrated. Here, the device 111 is a device configured to transmit/receive information to/from the optical transceiver 101 via the wiring 161d. Further, the optical transceiver 108 is an optical transceiver serving as the other party of the optical transceiver 101 and performing optical communication with the optical transceiver 101 via the optical path 121e.

The optical transceiver 101 includes a light adjusting section 141, a light emitting section 102a, a light receiving section 103a, a processing section 104, and a driving section 105. The optical transceiver 101 further includes optical paths 121a and 121b and wirings 151a, 151b, and 161a.

The above-described components included in the optical transceiver 101 are contained in a single case (housing), which is not illustrated.

The driving section 105 generates a driving signal for driving the light emitting section 102a on the basis of a signal transmitted from the processing section 104 through the wiring 151a. Further, the driving section 105 transmits a generated driving signal to the light emitting section 102a through the wiring 161a. The driving signal is generated on the basis of information transmitted from the device 111 via the processing section 104.

The light emitting section 102a is driven by the driving signal from the driving section 105, and guides a light signal corresponding to the driving signal to the optical path 121a. The light emitting section 102a includes, for example, a laser diode.

The optical path 121a guides the light signal, which is input thereto by the light emitting section 102a, to the light adjusting section 141. The optical path 121a is, for example, an optical fiber.

The light adjusting section 141 guides the light signal, which is guied by the optical path 121a, to the optical path 121e. Further, the light adjusting section 141 guides a light signal that is transmitted by the optical transceiver 108 through the optical path 121e to the optical path 121b.

The optical path 121b guides a light signal guided by the light adjusting section 141 to the light receiving section 103a.

The light receiving section 103a converts the light signal, which is guided by the optical path 121b, into a voltage signal corresponding to the light signal. Further, the light receiving section 103a transmits the voltage signal resulting from the conversion to the processing section 104 through the wiring 151b. Information included in the voltage signal is transmitted to the device 111 through the processing section 104. Further, the device 111 performs predetermined operation on the basis of the information.

The processing section 104 transmits a signal that allows the driving section 105 to generate the driving signal, to the driving section 105 through the wiring 151a, on the basis of information transmitted from the device 111 through the wiring 161d.

Further, the processing section 104 performs processing on the voltage signal, which is transmitted from the light receiving section 103a through the wiring 151b, and transmits information resulting from the processing to the device 111 through the wiring 161d.

The processing section 104 further acquires a voltage level of the voltage signal. Further, the processing section 104 records, at a predetermined timing point, the acquired voltage level into an unillustrated recording section included in the processing section 104. Further, the processing section 104 determines whether or not the amount of the reduction of the recorded voltage level from an initial value has exceeded a predetermined threshold value. Further, when having determined that the amount of the reduction of the recorded voltage level from the initial value has exceeded the predetermined threshold value, the processing section 104 records information representing the determination result into the recording section.

The information representing the determination result Is output to the outside. The output is performed via, for example, a serial bus, such as Inter-Integrated Circuit.

The optical transceiver 101 may be configured not to include the light adjusting section 141 and the optical paths 121a and 121b, in this case, the optical path 121e is configured to include components equivalent to the light adjusting section 141 and the optical paths 121a and 121b.

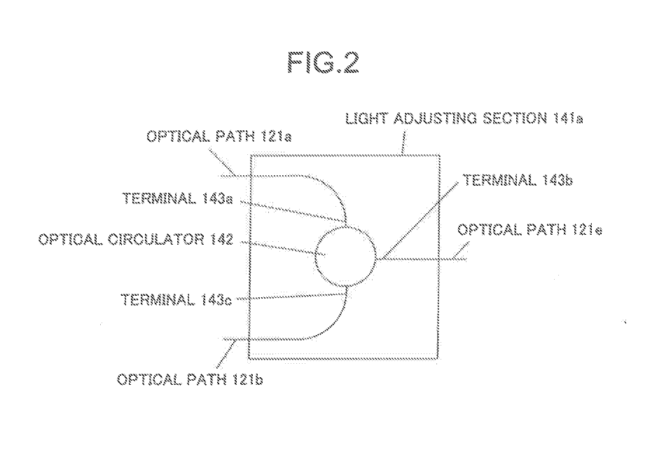

FIG. 2 is a conceptual diagram illustrating a configuration of a light adjusting section 141a, an example of the light adjusting section 141 shown in FIG. 1.

The light adjusting section 141a includes an optical circulator 142.

A light signal input to a terminal 143a of the optical circulator 142 from the optical path 121a is guided to the optical path 121e from the terminal 143b. Further, a light signal input to a terminal 143b of the optical circulator 142 from the optical path 121e is guided to the optical path 121b from the terminal 143c.

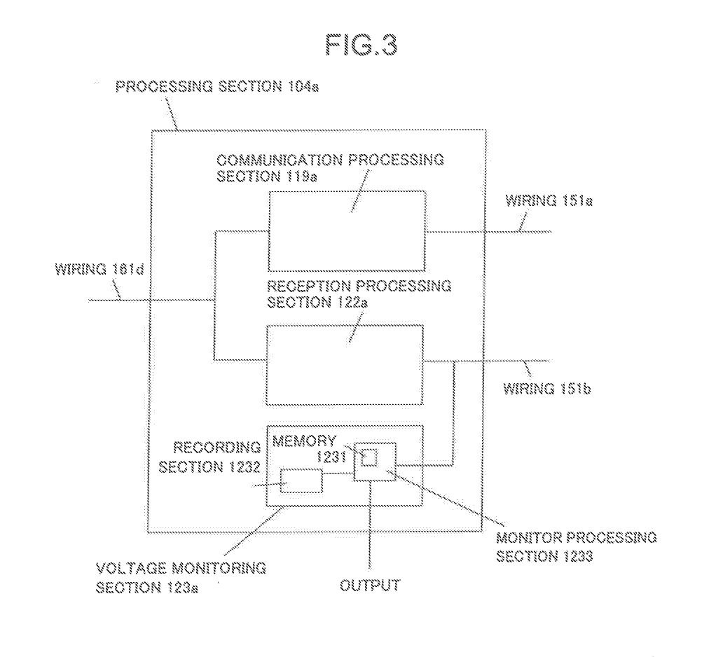

FIG. 3 is a conceptual diagram illustrating a configuration of a processing section 104a, an example of the processing section 104 shown in FIG. 1.

The processing section 104a includes a transmission processing section 119a, a reception processing section 122a, and a voltage monitoring section 123a.

The transmission processing section 119a generates a signal used for generating the above-described driving signal on the basis of information transmitted from the device 111, shown in FIG. 1, through the wiring 161d. The generated signal is transmitted to the driving section 105, shown in FIG. 1, through the wiring 151a.

The reception processing section 122a performs processing on the above-described voltage signal transmitted through the wiring 151b. Further, the reception processing section 122a transmits a signal including information resulting from the processing to the device 111, shown in FIG. 1, through the wiring 161d.

The voltage monitoring section 123a includes a monitor processing section 1233 and a recording section 1232. The monitor processing section 1233 includes a memory 1231.

The monitor processing section 1233 acquires, as any time, the signal amplitude of the voltage signal, transmitted through the wiring 151b. Further, the monitor processing section 1233 allows the recording section 1232 to record the acquired signal amplitude at a predetermined timing point. Every time the monitor processing section 1233 allows the recording section 1232 to record the acquired signal amplitude, the monitor processing section 1233 determines whether or not the amount of the reduction of the signal amplitude from an initial value has exceeded a predetermined threshold value. Further, when having determined that the amount of the reduction of the signal amplitude has exceeded the predetermined threshold value, the monitor processing section 1233 records a value representing an abnormal condition into the memory 1231. The value is output to the outside.

The monitor processing section 1233 allows the recording section 1232 to record information necessary to be retained during a long period. Meanwhile, the monitor processing section 1233 otherwise allows information unnecessary to be retained during a long period to be recorded into the memory 1231. The memory 1231 is DRAM or the like. Here, the DRAM is the abbreviation of Dynamic Random Access Memory.

The recording section 1232 is a recording section suitable to retaining recorded information during a long period. The recording section 1232 includes, for example, a nonvolatile memory. The memory is, for example, EEPROM or Flash ROM. Here, EEP is the abbreviation of Electrically Erasable Programmable. Further, ROM is the abbreviation of Read-Only Memory. The recording section 1232, including the nonvolatile memory, is capable of certainly retaining recorded information during a long period without losing the recorded information.

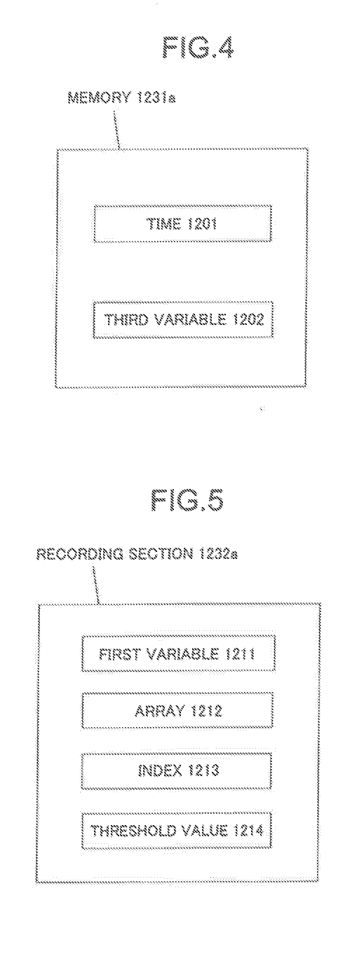

FIG. 4 is a conceptual diagram illustrating information retained by a memory 1231a, an example of the memory 1231 shown in FIG. 3.

As the information retained by the memory 1231a, a clock time 1201 output from a timer included in the monitor processing section 1233 and a third variable 1202 are assumed. The third variable 1202 is a value representing the presence or absence of the above-mentioned abnormal condition.

FIG. 5 is a conceptual diagram illustrating information retained by a recording section 1232a, an example of the recording section 1232 shown in FIG. 3.

The information includes a first variable 1211, an array 1212, an index 1213, and a threshold value 1214.

The first variable 1211 is an initial value of the above-described signal amplitude. As the initial value, it is preferable to use the signal amplitude in a state in which the value of the signal amplitude is sufficiently stable. As the initial value, for example, the signal amplitude at the time when a certain period of time has elapsed after the supply of electric power to the optical transceiver 101 is used. More specifically, as the initial value, for example, the signal amplitude at the time when one day has elapsed after the supply of electric power to the optical transceiver 101 is used.

The array 1212 is an array of the signal amplitude for each predetermined timing point. A value of the index 1213 described below is combined with the signal amplitude for each timing point. Further, the combination of the signal amplitude and the index 1213 constitutes one element of the array 1212. The recording section 1232a is capable of certainly retaining the signal amplitude for each predetermined timing point by retaining the signal amplitude for each predetermined timing point as the array 1212. Thus, when a user intends to confirm temporal transition of the signal amplitude afterward, the user is able to certainly execute the confirmation.

The index 1213 is a number given to an element of the array 1212. The value of the index 1213 is incremented by one every time an element is added to the array 1212.

The threshold value 1214 is a threshold value for use in a determination at a predetermined timing point on an abnormal condition of the amount of the reduction of the newest signal amplitude from the first variable 1211. As the threshold value 1214, a predetermined value is set before starting of the operation of the optical transceiver 101.

[Process Flow]

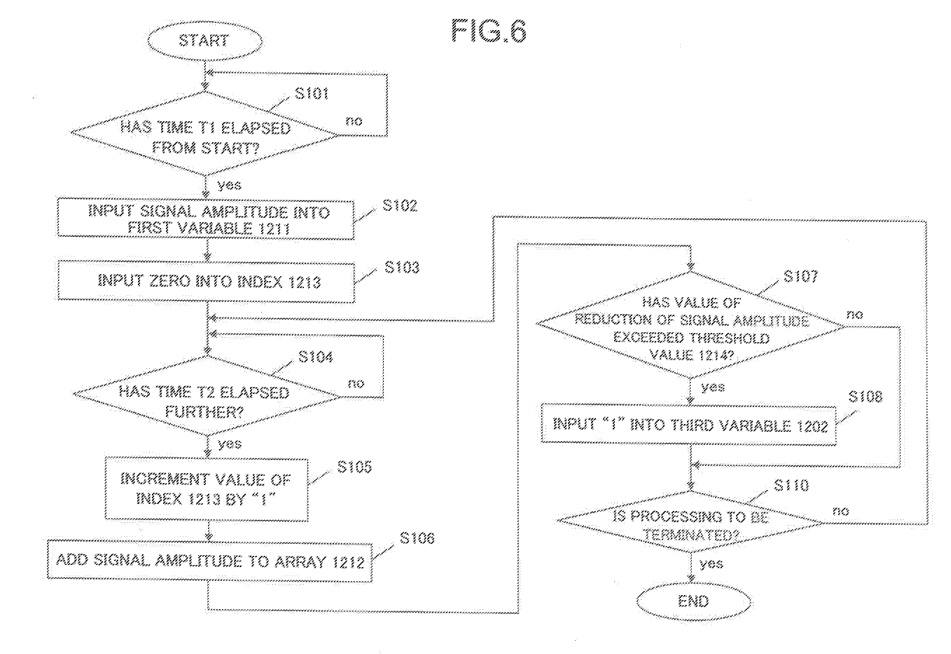

FIG. 6 is a conceptual diagram illustrating an example of a process flow for processing performed by the monitor processing section 1233 shown in FIG. 3.

The start of the process flow is a time point when electric source power is supplied to the optical transceiver 101.

First, in a process of S101, the monitor processing section 1233 determines whether or not a time T1 has elapsed from the start. Here, the time T1 is a time that is determined In advance on the basis of an assumption that the operation of the light receiving section 103a and any other component are stable when the time T1 has elapsed after the start of the supply of the electric source power. The time T1 is recorded in the recording section 1232 together with other pieces of information shown in FIG. 5 before the process of S101.

In the ease where the result of the determination in the process of S101 is “yes”, the monitor processing section 1233 performs a process of S102.

In contrast, in the case where the result of the determination in the process of S101 is “no”, the monitor processing section 1233 performs the process of S101 again.

When performing the process of S102, the monitor processing section 1233 inputs a value of the signal amplitude at the time of starting of the process of S102 into the first variable 1211.

Further, in the process of S103, the monitor processing section 1233 inputs zero into the index 1213.

Next, in the process of S104, the monitor processing section 1233 determines whether or not a time T2 has elapsed further from the immediately previous process (the process of S103 or “no” of S110). Here, the time T2 is a time that is determined in advance as an interval before the start of a process of S105 to be described later. The time T2 is recorded in the recording section 1232 together with other pieces of information shown in FIG. 5 before the process of S104.

In the case where the result of the determination in the process of S104 is “yes”, the monitor processing section 1233 performs a process of S105.

In contrast, in the case where the result of the determination In the process of S104 is “no”, the monitor processing section 1233 performs the process of S104 again.

When performing the process of S105, the monitor processing section 1233 increments the value of the index 1213 by “1”.

Further, in a process of S106, the monitor processing section 1233 combines a value of the index 1213 resulting from the execution of the process of S105 and the signal amplitude at the time of starting of the process of S106, and adds information resulting from the combination to the array 1212.

Further, in a process of S107, the monitor processing section 1233 determines whether or not a value of the reduction of the signal amplitude, having been added in the process of S106, from the signal amplitude, having been input to the first variable 1211 in the process of S102, has exceeded the threshold value 1214 shown in FIG. 5.

In the case where the result of the determination in the process of S107 is “yes”, the monitor processing section 1233 performs a process of S108.

In contrast, in the ease where the result of the determination in the process of S107 is “no”, the monitor processing section 1233 performs a process of S110.

Further, in the process of S108, the monitor processing section 1233 inputs “1” into the third variable 1202 shown in FIG. 5. Here the “1” of the third variable 1202 represents that the result of the determination in the process of S107 is “yes”.

Further, in the process of S110, the monitor processing section 1233 determines whether or not the processing shown in FIG. 6 is to be terminated.

In the case where the result of the determination in the process of S110 is “yes”, the monitor processing section 1233 terminates the processing shown in FIG. 6.

In contrast, in the case where the result of the determination in the process of S110 is “no”, the monitor processing section 1233 performs the above-described process of S104 again.

As described above, the optical transceiver 101 monitors the signal amplitude of the light signal transmitted from the optical transceiver 108, which is an optical transceiver serving as the other party of the optical transceiver 101, through the optical path 121e. Further, when having determined that the amount of the reduction of the amplitude from the initial value has exceeded beyond the threshold value 1214, the optical transceiver 101 outputs information representing the determination result.

Causes leading to the above determination result are assumed to be mainly three causes described below. The first one is the change of photoelectric conversion characteristics of the light receiving section 103a in the optical transceiver 101. The second one is the deterioration of the optical path 121e.

The third one is the change of photoelectric conversion characteristics of a light emitting section of the optical transceiver 108. The causes leading to the above determination result may include, in addition to the above three causes, the deterioration of a path for the light signal transmitted to the light receiving section 103a in the optical transceiver 101, and the deterioration of a path for the light signal transmitted from the light emitting section in the optical transceiver 108. These two kinds of deterioration, however, are very unlikely to occur because the paths are short optical paths inside the respective optical transceivers, and are protected by the housings of the respective optical transceivers.

Accordingly, the causes leading to the above determination result are assumed to be mainly the above three causes.

Further, it is already understood though experiences that the first one of the above three causes is caused by the temperature change of the light receiving section 103a along with the change of environmental temperature. Further, it is already understood though experiences that the third one of the above three causes is caused by the deterioration of characteristics of the light emitting section. Accordingly, in the case where it is already understood that the deterioration of characteristics of the light emitting section and the influence of the temperature change on the light receiving section 103a are each within an allowable range, it is understood that the above determination result is highly likely to be due to the deterioration of the optical path 121e.

Accordingly, the optical transceiver 101 can contribute to the determination of the deterioration of the optical path 121e.

Moreover, the optical transceiver 101 makes determinations on the increase of the signal amplitude from the initial value at predetermined intervals, Thus, the optical transceiver 101 determines the deterioration more accurately than in the method disclosed in Japanese Unexamined Patent Application Publication No. 4-242116, in which, for the signal amplitude, only a reduction from an immediately previous measurement value is determined.

Furthermore, the optical transceiver 101 includes a configuration that can contribute to the determination of the deterioration of the optical path 121e in the inside of the optical transceiver 101. Thus, the optical transceiver 101 makes it possible not to install the configuration that can contribute to the determination of the deterioration of the optical path 121e at the outside of the optical transceiver 101.

[Advantageous Effects]

The optical transceiver according to the present embodiment monitors the signal amplitude of a light signal transmitted from an optical transceiver serving as the other party through an optical path. Further, when having determined that the amount of the reduction of the signal amplitude from an initial value has exceeded beyond a threshold value, the optical transceiver outputs information representing the determination result. One of main ones of causes leading to the determination result is the deterioration of the optical path. Accordingly, the optical transceiver can contribute to the determination of the deterioration of the optical path.

Moreover, the optical transceiver makes determinations on the increase of the signal amplitude from the initial value at predetermined intervals. Thus, the optical transceiver determines the deterioration more accurately than in the method disclosed in Japanese Unexamined Patent Application Publication No. 4-242116, in which, for the signal amplitude, only a reduction from an immediately previous measurement value is determined.

Furthermore, the optical transceiver includes a configuration that can contribute to the determination of the deterioration of the optical path in the inside of the optical transceiver. Thus, the optical transceiver makes it possible not to install the configuration that can contribute to the determination of the deterioration of the optical path at the outside of the optical transceiver.

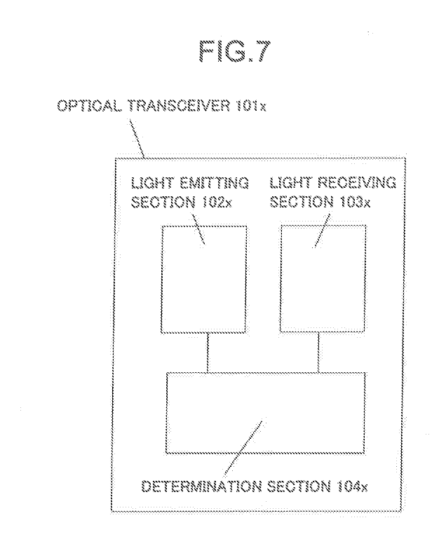

FIG. 7 is a block diagram illustrating a configuration of an optical transceiver 101x, an optical transceiver having a minimum configuration of the optical transceiver according to the present invention.

The optical transceiver 101x includes a light emitting section 102x, a light receiving section 103x, and a determination section 104x.

The light emitting section 102x transmits a first light signal to a second optical transceiver (not illustrated) through an optical path (not illustrated).

The light receiving section 103x receives a second light signal transmitted from the second optical transceiver through the optical path.

The determination section 104x outputs the result of a determination on the amount of the change from an initial value to a value representing a received light amount in the reception by the light receiving section with respect to the second optical signal obtained at a predetermined timing point.

Since the received light amount is a light amount of a light signal input to the light receiving section through the optical path, the received light amount is affected by the deterioration of characteristics of the optical path. Moreover, the determination section 104x makes determinations on the deterioration of characteristics of the optical path on the basis of a plurality of the values obtained at predetermined intervals. Thus, the probability allowing the deterioration of the optical path to be correctly determined is high.

Furthermore, the determination is made inside the optical transceiver 101x. This configuration, therefore, makes it possible not to install a device for measuring the deterioration of characteristics of the optical path at the outside of the optical transceiver.

With the above configuration, therefore, the optical transceiver 101x brings about the advantageous effects having been described in “Advantageous Effects”.

The individual embodiments of the present invention have been described so far, bat the present invention is not limited to the foregoing embodiments, and further modifications, replacements, and adjustments can be added within the scope not departing from the fundamental technical thought of the present invention. For example, the configuration of the elements shown in each of the figures is just an example to help understanding of the present invention, and the present invention is not limited to the configurations shown in the figures.

The whole or part of the example embodiments disclosed above can be described as, but not limited to, the following supplementary notes.

(Supplementary Note 1)

An optical transceiver Including a light emitting section configured to transmit a first light signal to a second transceiver via an optical path; a light receiving section configured to receive a second light signal transmitted from the second optical transceiver via the optical path; and a determination section configured to output a result of a determination on an amount of a change from an initial value to a value representing a received light amount in the reception by the light receiving section with respect to the second optical signal obtained at a predetermined timing point.

(Supplementary Note 2)

The optical transceiver according to Supplementary Note 1, wherein the determination is a determination on deterioration of characteristics of the optical path.

(Supplementary Note 3)

The optical transceiver according to Supplementary Note 1 or Supplementary Note 2, wherein the determination is made by comparing a magnitude of the amount of the change with a magnitude of a threshold value.

(Supplementary Note 4)

The optical transceiver according to any one of Supplementary Notes 1 to 3, further including a recording section configured to record information for use in the determination.

(Supplementary Note 5)

The optical transceiver according to Supplementary Note 4, wherein the information for use in the determination includes a first variable representing an initial value of a value representing the received light amount.

(Supplementary Note 6)

The optical transceiver according to Supplementary Note 4 or Supplementary Note 5, wherein the information for use in the determination includes a second variable representing the value representing the received light amount.

(Supplementary Note 7)

The optical transceiver according to any one of Supplementary Notes 3 to 6, wherein the information for use in the determination includes an array of values each representing the received light amount at a corresponding one of predetermined time intervals.

(Supplementary Note 8)

The optical transceiver according to any one of Supplementary Notes 3 to 7, wherein the information for use in the determination includes the threshold value.

(Supplementary Note 9)

The optical transceiver according to any one of Supplementary Notes 3 to 8, wherein the information for use in the determination is retained by the recording section as nonvolatile recorded information.

(Supplementary Note 10)

The optical transceiver according to any one of Supplementary Notes 1 to 9, wherein the light emitting section, the light receiving section, and the determination section are contained in a single case.

(Supplementary Note 11)

The optical transceiver according to any one of Supplementary Notes 1 to 10, further including a light adjusting section configured to guide the first light signal from the light emitting section to the optical path, and to guide the second light signal from the optical path to the light receiving section.

(Supplementary Note 12)

The optical transceiver according to any one of Supplementary Notes 1 to 11, further including a driving section configured to transmit a signal electric current corresponding to the first light signal.

(Supplementary Note 13)

The optical transceiver according to Supplementary Note 12, further including a first processing section configured to transmit a voltage signal corresponding to the signal electric current to the driving section.

(Supplementary Note 14)

The optical transceiver according to any one of Supplementary Notes 1 to 13, further including a second processing section configured to perform processing on a voltage signal corresponding to the second light signal from the light receiving section.

(Supplementary Note 15)

The optical transceiver according to any one of Supplementary Notes 1 to 14, wherein the output is performed via Inter-Integrated Circuit.

(Supplementary Note A1)

A device configured to transmit first signal information, that is, information included in the first light signal, to the optical transceiver according to any one of Supplementary Notes 1 to 15.

(Supplementary Note A2)

A device including the optical transceiver according to any one of Supplementary Notes 1 to 15 and configured to transmit the first signal information, that is, information included in the first light signal, to the optical transceiver.

(Supplementary Note B1)

A device configured to perform predetermined operation on the basis of second information, that is, information included in the second light signal transmitted by the optical transceiver according to any one of Supplementary Notes 1 to 15.

(Supplementary Note B2)

A device including the optical transceiver according to any one of Supplementary Notes 1 to 15 and configured to perform predetermined operation on the basis of second Information that is included in the second light signal and that is transmitted by the optical transceiver.

(Supplementary Note C1)

A device configured to transmit first signal information, that is, information included in the first light signal, to the optical transceiver according to any one of Supplementary Notes 1 to 15, and to perform predetermined operation on the basis of second information, that is, information included in the second light signal and transmitted by the optical transceiver according to the any one of Supplementary Notes 1 to 15.

(Supplementary Note D1)

A device including the optical transceiver according to any one of Supplementary Notes 1 to 15 and configured to transmit first signal information, that is, information included in the first light signal, to the optical transceiver, and to perform predetermined operation on the basis of second information, that is, information included in the second light signal and transmitted by the optical transceiver.

### REFERENCE SIGNS LIST

101, 101x, 108: optical transceiver

102a, 102x: light emitting section

103a, 103x: light receiving section

104, 104a: processing section

104x: determination section

105: driving section

111: device

119a: transmission processing section

121a, 121b, 121e: optical path

122a: reception processing section

123a: voltage monitoring section

1231, 1231a: memory

1232, 1232a: recording section

1233: monitor processing section

141, 141a: light adjusting section

142: optical circulator

143a, 143b, 143c: terminal

151a, 151b, 161a, 161d: wiring

The previous description of embodiments is provided to enable a person skilled in the art to make and use the present invention.

Moreover, various modifications to these example embodiments will be readily apparent to those skilled in the art, and the generic principles and specific examples defined herein may be applied to other embodiments without the use of inventive faculty.

Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

While the invention has been particularly shown and described with reference to example embodiments thereof, the invention is not limited to these embodiments.

It will be understood by those of ordinary skill in the art that various changes in form and details may be made therein without departing from the spirit and scope of the present Invention as defined by the claims.

What is claimed is:

1. An optical transceiver including a light emitter configured to transmit a first light signal to a second transceiver via an optical path; a light receiver configured to receive a second light signal transmitted from a second optical transceiver via the optical path; and a determiner configured to output a result of a determination on an amount of a change from an initial value to a value representing a received light amount in reception by the light receiver with respect to the second optical signal obtained at a predetermined timing point.

2. The optical transceiver according to claim 1, wherein determination by the determiner is determination on deterioration of characteristics of the optical path.

3. The optical transceiver according to claim 1, wherein the determination is made by comparing magnitude of the amount of change with magnitude of a threshold value.

4. The optical transceiver according to claim 1, further including a memory configured to record information for use in the determination.

5. The optical transceiver according to claim 4, wherein information for use in the determination includes a first variable representing an initial value of a value representing the received light amount.

6. The optical transceiver according to claim 4, wherein information for use in the determination includes a second variable representing the value representing the received light amount.

7. The optical transceiver according to claim 3, wherein information for use in the determination includes an array of values each representing the received light amount at a corresponding one of predetermined time intervals.

8. The optical transceiver according to claim 3, wherein information for use in the determination includes the threshold value.

9. The optical transceiver according to claim 3, wherein information for use in the determination is retained by a memory as nonvolatile recorded information.

10. The optical transceiver according to claim 1, wherein the light emitter, the light receiver, and the determiner is contained in a single case.

11. The optical transceiver according to claim 1, further including a light adjuster configured to guide the first light signal from the light emitter to the optical path, and to guide the second light signal from the optical path to the light receiver.

12. The optical transceiver according to claim 1, further including a driver configured to transmit a signal electric current corresponding to the first light signal.

13. The optical transceiver according to claim 12, further including a first processor configured to transmit a voltage signal corresponding to the signal electric current to the driver.

14. The optical transceiver according to claim 1, further including a second processor configured to perform processing on a voltage signal corresponding to the second light signal from the light receiver.

15. The optical transceiver according to claim 1, wherein output are performed via inter-Integrated Circuit.

16. A device configured to transmit first signal information, that is, information included in the first light signal, to the optical transceiver according to claim 1.

17. A device including the optical transceiver according to claim 1 and configured to transmit first signal information, that is, information included in the first light signal, to the optical transceiver.

18. A device configured to perform predetermined operation on the basis of second information, that is, information included in the second light signal transmitted by the optical transceiver according to claim 1.

19. A device including the optical transceiver according to claim 1 and configured to perform predetermined operation on the basis of second information that is included in the second light signal and that is transmitted by the optical transceiver.

20. A device configured to transmit first signal information, that is, information included in the first light signal, to the optical transceiver according to claim 1, and to perform predetermined operation on the basis of second information, that is, information included in the second light signal and transmitted by the optical transceiver according to claim 1.
